(19) United States
(12) Patent Application Publication
(10) Pub. No.: US 2020/0315201 A1
(43) Pub. Date: Oct. 8, 2020

(54) Method and Apparatus for the Enhancement of the Aqueous Extraction of Plant Material

(71) Applicant: Teknolerge Limited, Henley-On-Thames (GB)

(72) Inventor: William John Henry, St. Andrews, Fife (GB)

(21) Appl. No.: 16/768,135

(22) PCT Filed: Dec. 3, 2018
(86) PCT No.: PCT/GB2018/053493

§ 371 Date: May 29, 2020

(30) Foreign Application Priority Data
Dec. 1, 2017 (GB) 1720019.7

(51) Int. Cl. A23F 3/18; A23L 5/30; A47J 31/52

(52) U.S. Cl. CPC A23F 3/18; A23V 2002/00; A47J 31/521; A23L 5/30

(57) ABSTRACT

An apparatus and method for improving extraction of one or more components from a plant material when adding a hot, cold or mid-temperature liquid to the plant material to cause extraction of one or more components. During, or after, addition of the liquid it is exposed to electromagnetic signals at one or a range of frequencies. The signals are provided in a pulsed manner creating periods of electromagnetic frequency signals and periods where there are none, which enhances extraction of one or more components. In an embodiment the liquid water is added to the plant material to create a beverage such as a tea or infusion. In an embodiment the electromagnetic emitting means can be suitably designed to controlled apparatus and in another it is a smartphone tablet or similar device with a controlling app thereon.

The invention to which this application relates is to the use of a sequence of digital radio signals from apparatus to enhance the aqueous extraction of plant material.

Aqueous extraction, either hot or cold, of plant material such as the leaves from the plant Camelia Senensis to make a tea is a common and frequent practice throughout the world. The leaves of Camelia Senensis are prepared in several ways, mostly by drying and or malting. This provides a huge range of dry teas, Green, Black, and White etc., which can be kept in the dry state for extended periods of time and the teas are then made into a beverage by aqueous extraction in either hot or cold water and this process has many variables such as temperature and infusion time. In all cases however, the objective is to extract various plant compounds that are contained in the dry plant material to make a water-based drink to the requirements of the user. In the case of Camelia-based teas, the user has a large choice of teas to choose from and with regard to different possible infusion types, can have further options in the type and quality of the final beverage created.

Tea based beverages are made and taken for many reasons, ranging from the simple need to hydrate to the complexities of modifying mood and energy states. Included in this range are various other needs and benefits. For example green tea components such as coumarin can be used to calm or suppress appetite and many diet regimes include green tea for this reason. Likewise teas can provide many and varied compounds which are taken for the reason of benefits to human health. Antioxidants such as the catechin group of compounds are a good example of how human health can benefit from the extraction of plant material by water for the purposes of drinking.

In the above examples, the plant material is mainly the leaves of plants but other parts of the plant such as root, stalk and petioles are also prepared for aqueous extraction for similar reasons. The types of plant are also wide ranging and are extracted and drunk for similar reasons of pleasure, mood enhancing or general human health benefits.

In an industrial setting an infusion can be enhanced by for example the use of pressure. If an extraction is performed with the aim of concentrating a particular compound, this may be increased by applying pressure during a hot extraction to raise the temperature and hence the capacity of water to extract and solubilise this compound. However, this is not practical in a domestic setting and indeed the increase in effective temperature may deliver unwanted properties. Despite the acknowledged benefits of beverages of this type there are known limitations of aqueous extractions as practised in domestic households and the process by which the extractions are made have not changed much for millennia. The dried or fresh plant material is combined with hot or cold water and infused for a duration that depends on the particular needs of the user. Unwanted properties can include bitterness in the beverage. In the case of Japanese green tea, the infusion temperature is optimised for taste at 70 degrees centigrade but at this temperature the extraction of say coumarin for dieting purposes is reduced to what it could be if extracted at 100 degrees centigrade.

Similarly, other compounds that are important for human health such as the Flavenoids can be extracted more efficiently at temperatures elevated above 70 degrees centigrade that is the preferred temperature in terms of taste. This then is a limitation that the tea drinking consumer has to withstand.

Moreover, even at 100 degrees centigrade, aqueous extraction (infusion) of for example green tea, there is still a limitation to the amount that be accommodated in water at this temperature. This is as a consequence of the chaotic structure of water that has a decreased solubilising capacity, see description of invention which solves the above limitations.

An aim of the present invention is to provide apparatus and a method which enhances the ability to extract one or more components from a plant material.

In a first aspect of the invention there is provided apparatus to allow for the improved extraction of at least one component from a plant material with a liquid added thereto, said apparatus including means for emitting an electromagnetic signal at one or a range of radio frequencies within a predetermined range of frequencies and locating said plant material and liquid at a distance from the emitting means such that the electromagnetic signal passes into the plant material and liquid to enhance said extraction of said one or more components from said plant material.

In one embodiment the said means is one or more smartphones or similar device which can emit a range of radio frequencies to augment the aqueous extraction process of plant material.

In one embodiment it has been found that in particular the radio frequency of a personal area network system, which is engineered to produce an electromagnetic signal substantially at 2.4 GHz, and typically within the Industrial, Scientific and medical band, ISM, of the electromagnetic spectrum can be exploited.

In one embodiment the electromagnetic signals is controlled so as to produce a 1 ms burst or pulse of the required electromagnetic signal and by ensuring this burst is separated by a rest period of for example 60 ms, it has been found this has a dramatic effect on the structure of the water and hence its ability to extract plant compounds from plant material such as tea leaves from Camelia senensis.

In one embodiment the device can be programmed, such as by using an app, to produce pulses of 1 ms at around 15 to 200 pulses per second and the device is placed adjacent to, such as directly underneath a hot or cold water-based infusion of plant material in the process of, in one embodiment, the steps for making tea. In one embodiment if the apparatus is a smartphone the same may be leaned against the vessel, such as a cup or teapot, in which the infusion is being prepared.

In one embodiment the infusion vessel is made of a non-metallic materials, such as ceramic or glass and the pulsed electromagnetic signal which is emitted is allowed to permeate the infusion during the infusion process.

In one embodiment the application of the electromagnetic signal enhances the extraction of desired compounds from the plant material. In one embodiment when a beverage is created by the addition of the water to tea leaves the umami is improved and there is a reduction in the perceived bitterness of the final tea.

In one embodiment green tea is enhanced in antioxidant pigments and in coumarin, which, in tests, was found to have increased by 70% in comparison to conventional infusion methods, in addition to the reduction in bitter flavours and enhancement of the Umami or structural qualities of the tea.

It is found that the resulting tea treated in this manner in accordance with the invention has a much improved taste and texture with a marked increase in umami.

A method for performing an extraction of at least one component from a plant material, said method including the steps of adding a liquid to the plant material and wherein during or after the said addition of the liquid, exposing the liquid and plant material mixture to electromagnetic signals emitted at one or a range of frequencies so as to cause the extraction enhancement.

In one embodiment the said electromagnetic signals are provided in a pulsed manner such that there is a sequence of a period of time during which the electromagnetic signals are generated and a period of time when they are not. In one embodiment the sequence is repeated for a predetermined period of time.

In one embodiment the liquid is water and is added to the plant material to create a drink. In one embodiment the means to emit the electromagnetic signals is any of a smartphone, tablet or similar device with an app thereon to control the emission of the electromagnetic signals.

In one embodiment the said electromagnetic signal emitting means and the vessel in which the said liquid and plant material mixture is located are respectively positioned so as to allow the electromagnetic signals which are emitted to pass through the walls of the vessel and into the said mixture.

In one embodiment the means to emit the electromagnetic signals is provided with a housing and a location portion thereon to allow a vessel in which the plant material mixture is provided, to be located so as to allow the passage of the said electromagnetic signals through the walls of the vessel and into the said mixture.

In one embodiment the drink is a tea or infusion and typically the tea or infusion which has been exposed to the electromagnetic signals has increased umami in comparison to a tea or infusion formed of the same plant material and liquid which is not exposed to said electromagnetic signals.

In one embodiment the plant material is or includes material derived from any, or any combination of, the camelia senensis plant, the mint plant, the camomile plant, the St Johns wort plant, the fennel plant, the echinacea plant, and/or the blackcurrant plant.

In one embodiment the liquid can be added to the plant material when the liquid has been heated to be at or close to boiling point, may be cold tap water temperature or may be mid-temperature.

The above observation is extraordinary and surprising since experience of tea making would predict that longer, hotter and/or more intense extraction of plant material would result in a decrease in the drinking pleasure.

Specific examples of the invention are now provided with reference to the accompanying drawings; wherein

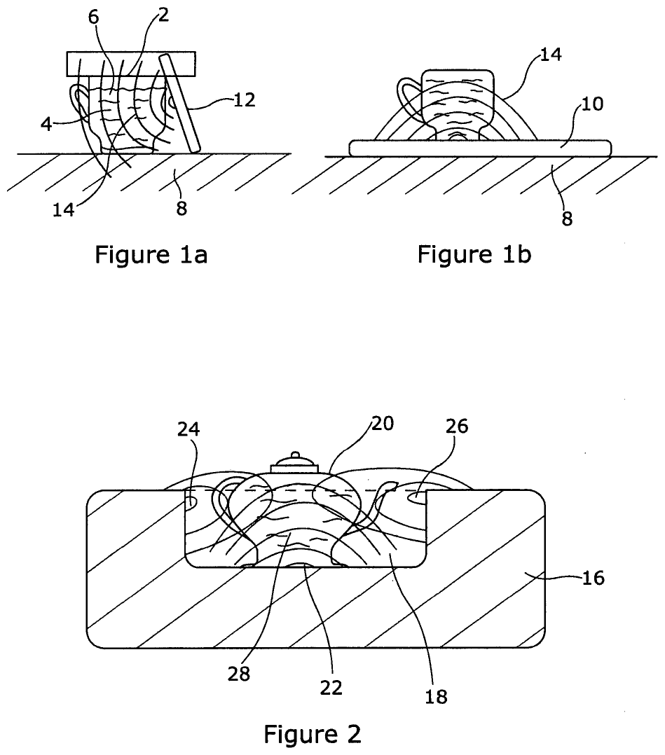

FIGS. 1a and b illustrate the use of electromagnetic signal emitting means in one form in accordance with the invention; and

FIG. 2 illustrates the use of electromagnetic signal emitting means in accordance with a second embodiment of the invention.

Referring now to FIGS. 1a and b there is illustrate in both drawings a vessel 2 in the form of a cup which has a cavity 4 in which a plant material and water mixture 6 is contained. In FIG. 1a the cup is placed on a support surface 8 such as akitched worktop and in FIG. 1b the cup 2 is placed on a table computing device 10 which in turn is located on a support surface 8. In FIG. 1a a smartphone device 12 is shown leant against the cup 2. In both Figures a and b the smartphone and tablet device have the ability to emit electromagnetic signals, typically within a predetermined range and in accordance with the invention a device control app has been downloaded onto the device so as to control the operation of the device to emit the electromagnetic signals at one or a number of predetermined frequencies and, in one embodiment, in a pulsed manner.

The relative position of the cup 2 and device 12, or 10 is such that the cup, and the plant material and liquid mixture 10 therein is positioned within the range 14 of the electromagnetic signals emitted from the device 0,12 so that the signals have the required effect on the plat material and liquid mixture so as to enhance the extraction of one or components from the plant material and into the liquid. In one embodiment the plant material is provided as loose leaves or may be provided in a bag such as a teabag, located in the liquid 6 in the cavity 4.

FIG. 2 illustrates an alternative embodiment and in this case the apparatus 16 for emitting the electromagnetic signals is provided as a housing (shown in cross section) with a location portion 18 for the receipt therein of a vessel (typically a larger vessel, such as a teapot 20 or larger vessel) which includes therein the liquid and plant material mixture 28. In this case the housing includes three electromagnetic signal emitting sources 22,24,26, each of which emits signals over a range such that, in combination, it can be ensured that the plant material and liquid mixture in the vessel is exposed to the electromagnetic signals for the desired period of time.

Examples of the invention being used are now described.

### EXAMPLE 1 (HOT INFUSION OF JAPANESE, SENCHA, GREEN TEA) 83

A world-renowned tea master, with particular skills in the subtleties of Japanese Green Tea was commissioned to study the effect of pulsed radio signals from a smartphone on hot infusion of Sencha tea. The master was provided with apparatus in the form of a smartphone and specifically a Samsung Galaxy S4 loaded with a controlling app in accordance with the invention. In one embodiment the app was that known as apZap which is obtainable from the Google® play store.

The tea master prepared 2 ceramic teapots for infusion by introducing 2.5 grammes of Sencha tea and onto the leaves was poured 160 mls of water at 70 degrees centigrade. One teapot was placed in another room while the other teapot was subjected 15 1 ms pulsed radio signals of 2.4 GHz per second. These pulses were generated by starting apZap and placing the smartphone immediately adjacent to the teapot.

During the running of apZap, the phone was placed on flight mode to isolate the 2.4 GHz 1 ms pulsed signal. After 4 minutes, the app was stopped and the two pots were sampled for tea by normal procedure of straining into identical ceramic tea mugs.

The tea master reported that the infusion which had been augmented by smartphone running the app apZap, by comparison to the control (non-apZap) sample was; “distinctly different” “was smoother, with more mineral character. It had much less bitterness and less vegetal character”

### EXAMPLE 2, HOT INFUSED, JAPANESE, SENCHA, GREEN TEA 102

Two samples of Japanese Green Tea were produced by the identical method of example 1. Once again, one was subjected to pulsed EM signal from a Samsung Galaxy S4 using the app apZap. The other infusion was performed in a separate room distant from any influence of the smartphone signal. After 4 minutes infusion each tea in turn was separated from the leaves into two sample bottles and labelled.

Visual assessment of the two samples identified a distinct difference in colour intensity. Sample 1, which was prepared with the presence of pulsed 2.4 GHz by comparison to the control sample 2 was several shades deeper in yellow and green. Sample 1 by comparison to sample 2, the control, appeared to be a “stronger” tea.

The samples were then delivered to an analytical laboratory and the accredited laboratory, which specialises in food and drink analysis, performed chromatographic validated procedure to assess for coumarin content. The results were as follows;

Sample 1 Green tea infused in the presence of pulsed 2.4 GHz,

coumarin concentration=0.029 mg/kg

Sample 2 Green Tea normal infusion, Control.

Coumarin concentration=0.017 mg/kg

### EXAMPLE 3. HOT INFUSION OF ECHINACEA AND RASPBERRY FRUIT TEA

Two samples of Twinings Echinacea and Raspberry fruit were prepared for hot infusion. The fruit tea bags were placed in separate heat-proof glass mugs. To each of the mugs was added 250 mls of hot water from a previously boiled kettle. One mug was placed in a separate room while the other was subjected to pulsed 2.4 GHz from a Samsung Galaxy S4 employing the apZap app. The infusion lasted 5 minutes after which time the app was stopped and the two samples compared for colour taste and texture.

### Summary of Experimental Evidence from Examples

The use of a smartphone with a pulsed digital signal during the aqueous extraction of plant material in the process of making tea (infusion process) enhances the extraction to provide greater concentration of key compounds in the final tea (as evidenced by the increased pigmentation and the chemical analysis of higher coumarin content). The use of the digital signal also minimises the bitterness and enhances the umami and flavour experience (as evidenced by the report from a world-renowned tea master).

1. Apparatus to allow for the improved extraction of at least one component from a plant material with a liquid added thereto, said apparatus including emitting means for emitting electromagnetic signals at one or a range of frequencies within a predetermined range of frequencies and providing locating means to locate said plant material and liquid at a distance from the emitting means such that the electromagnetic signals pass into the plant material and liquid to enhance said extraction of said at least one component from said plant material wherein the electromagnetic signal is emitted as a series of pulses during the infusion of the plant material with the liquid.

2. Apparatus according to claim 1 wherein the emitting means emits a sequence of digital radio electromagnetic signal pulses during the infusion of the plant material with the liquid.

3. Apparatus according to claim 1 wherein the plant material is a tea.

4. Apparatus according to claim 3 wherein the liquid is hot and hot infusion or mixture with the tea plant material creates a tea with an enhanced extraction of components from the tea plant material.

5. Apparatus according to claim 1 wherein the apparatus is used during application of a cold liquid to the plant material and the extraction of one or more components of the plant material.

6. Apparatus according to claim 1 wherein emission of the electromagnetic signals is such as to be applied through walls of a vessel in which the plant mixture and liquid is contained.

7. Apparatus according to claim 1 wherein the said emitting means is any or any combination of a smartphone, tablet device or other user controlled data processing and signal emitting device thereby allowing the apparatus to be used in a domestic environment.

8. Apparatus according to claim 7 wherein the said device is controlled to emit the electromagnetic signals via application software (app) downloaded onto their device.

9. A method for performing an extraction of at least one component from a plant material, said method including the steps of:
adding a liquid to the plant material and
wherein during or after the said addition of the liquid, exposing the liquid and plant material mixture to electromagnetic signals emitted at one or a range of frequencies so as to cause extraction enhancement.

10. A method according to claim 9 wherein the said electromagnetic signals are provided in a pulsed manner such that there is a sequence of a period of time during which the electromagnetic signals are generated and a period of time when they are not.

11. A method according to claim 10 wherein the sequence is repeated for a predetermined period of time.

12. A method according to claim 9 wherein the liquid is water and is added to the plant material to create a drink.

13. A method according to claim 9 wherein the means to emit the electromagnetic signals is any of a smartphone, tablet or similar device with an app thereon to control the emission of the electromagnetic signals.

14. A method according to claim 9 wherein the said electromagnetic signal emitting means and a vessel in which the said liquid and plant material mixture is located are respectively positioned so as to allow the electromagnetic signals which are emitted to pass through walls of the vessel and into the said plant material mixture.

15. A method according to claim 9 wherein the means to emit the electromagnetic signals is provided with a housing and a location portion to allow a vessel in which the plant material and liquid mixture is provided, to be located so as to allow passage of the said electromagnetic signals through walls of the vessel and into the said plant material mixture.

16. A method according to claim 12 wherein the drink is a tea or infusion.

17. A method according to claim 16 wherein the tea or infusion exposed to the electromagnetic signals has increased umami in comparison to a tea or infusion formed of the same plant material and liquid which is not exposed to said electromagnetic signals.

18. A method according to claim 9 wherein the plant material is or includes material derived from any, or any combination of, the camelia senensis plant, the mint plant, the camomile plant, the St Johns wort plant, the fennel plant, the echinacea plant, and/or the blackcurrant plant.

19. Apparatus for the extraction of at least one component from a material, said apparatus including one or more electromagnetic signal emitters to emit electromagnetic signals at one or a range of frequencies within a predetermined range of frequencies and locating means to locate a vessel in which said material is held and said one or more electromagnetic signal emitters at a selected distance such that the emitted electromagnetic signals pass through a vessel and into the said material to cause and/or enhance extraction of said at least one component from said material wherein the one or more electromagnetic signal emitters is controlled to emit said electromagnetic signals as a series of pulses prior to and/or during the extraction of said at least one component.

20. A method for the extraction of at least one component from a material, said method including the steps of; locating a vessel in which said material is held and one or more electromagnetic signal emitters at a selected distance, emitting electromagnetic signals from said one or more electromagnetic signal emitters at one or a range of frequencies within a predetermined range of frequencies, such that the emitted electromagnetic signals pass through the vessel and into the said material to cause and/or enhance extraction of said at least one component from said material and wherein the said electromagnetic signals are emitted as a series of pulses prior to and/or during the extraction of said at least one component.
